(19) United States
(12) Patent Application Publication
(10) Pub. No.: US 2024/0136882 A1
(43) Pub. Date: Apr. 25, 2024

(54) MOTOR AND MOTOR ASSEMBLING METHOD

(71) Applicant: NIDEC CORPORATION, Kyoto (JP)

(72) Inventors: Yu WANG, DALIAN CITY (CN); Keisuke YOSHINO, Kyoto (JP); Yonggang YANG, DALIAN CITY (CN); Masashi OMI, Kyoto (JP)

(73) Assignee: NIDEC CORPORATION, Kyoto (JP)

(21) Appl. No.: 18/489,835

(22) Filed: Oct. 17, 2023

(30) Foreign Application Priority Data
Oct. 19, 2022 (CN) 202211285757.0

(51) Int. Cl. H02K 5/06; H02K 5/16; H02K 15/14

(52) U.S. Cl. CPC H02K 5/06; H02K 5/161; H02K 15/14

(57) ABSTRACT

The disclosure provides a motor and a motor assembling method. The motor includes a housing having a bottom and a wall portion extending from an edge of the bottom along an axial direction, and a lid connected to the housing on one side in the axial direction of the bottom of the housing. A surface on the one side in the axial direction of the bottom of the housing has a first connection surface. Housing portions on an inside and an outside in a radial direction of the first connection surface are respectively bent in opposite directions intersecting the first connection surface, which ensures sufficient working space when performing work for connecting the housing and the lid.

### CROSS REFERENCE TO RELATED APPLICATIONS

The present application claims priority under 35 U.S.C. § 119 to Chinese Application No. 202211285757.0 filed on Oct. 20, 2022 the entire contents of which are hereby incorporated herein by reference.

### FIELD OF THE INVENTION

The disclosure relates to a motor and a motor assembling method.

### BACKGROUND

In a conventional motor, the housing and the lid are both aluminum castings and may be connected together by screws. With such a conventional motor, the number of motor components increases with the number of screws used to connect the housing and the lid. As a result, the cost of the motor becomes higher.

The above description of the background art is provided to facilitate a clear and complete explanation of the technical solutions disclosed herein, as well as to enhance the understanding of those skilled in the art. It should not be construed as implying that it is well-known to those skilled in the art.

For example, in response to mounting the motor and an external device such as an EPS (electric power steering), depending on the specifications required by the external device, the distance (axial direction distance) between the upper edge portion of the lid and the surface on which the through holes around the lid are provided has to meet certain dimensions while connecting the external device and the motor via the through holes with the upper edge portion of the lid facing the external device.

In addition, in order to reduce the cost, the discloser considered utilizing iron pressed articles instead of aluminum castings to construct the housing and the lid and inserting the bottom of the housing into a recessed portion of the lid, and connecting the lid and the housing through TOX (registered trademark) caulking. However, when the requirement for the distance between the surface on which the through holes are provided and the upper edge portion of the lid is met using a stepped structure of the lid, the distance between two sides in the radial direction of the TOX caulking position is too close. As a result, the TOX caulking tool is unable to be inserted, which may make the work more difficult.

### SUMMARY

A motor according to an example of embodiment of the disclosure includes a housing having a bottom and a wall portion extending from an edge of the bottom along an axial direction; and a lid connected to the housing on one side in the axial direction of the bottom of the housing. A surface on the one side in the axial direction of the bottom of the housing has a first connection surface, and housing portions on an inside and an outside in a radial direction of the first connection surface are respectively bent in opposite directions intersecting the first connection surface.

Further, a motor assembling method according to an example of embodiment of the disclosure is provided for assembling a motor which includes a bottom and a wall portion extending from an edge of the bottom along an axial direction and in which a surface on one side in the axial direction of the bottom of a housing has a first connection surface. The motor assembling method includes: defining the housing having housing portions on two sides in a radial direction of the first connection surface, which are respectively bent in opposite directions intersecting the first connection surface; defining a lid whose surface facing the first connection surface is a second connection surface; inserting the lid into the housing along the axial direction; and defining a TOX connection structure recessed from the one side in the axial direction toward other side in the axial direction on the first connection surface and the second connection surface.

The following description and drawings provide a detailed explanation of example of embodiments disclosed herein. However, it should be understood that the scope and terms of the claims are not limited thereto and encompass various modifications, variations, and equivalents.

The term “and/or” as used in this specification refers to the same or similar manner of usage, whether in one or more other embodiments, in combination with other embodiments, or as a substitution for certain components in other embodiments.

The term “comprising/including/having” indicates the presence of a technical feature, component, or assembly, but does not exclude the presence of one or more other technical features, components, or assemblies.

### BRIEF DESCRIPTION OF THE DRAWINGS

FIG. 1 is a perspective view of an example of motor according to the disclosure.

FIG. 2 is a longitudinal cross-sectional view of the example of motor according to the disclosure.

FIG. 3 is a perspective view of the housing of the example of motor according to the disclosure.

FIG. 4 is a perspective view of the lid of the example of motor according to the disclosure.

FIG. 5 is a longitudinal cross-sectional view of the example of motor according to the disclosure when the housing and the lid are connected by TOX caulking.

FIG. 6 is a longitudinal cross-sectional view of the example of motor according to the disclosure immediately after the housing and the lid have been connected by TOX caulking.

FIG. 7 is a longitudinal cross-sectional view of the example of motor according to the disclosure when connection between the housing and the lid has been completed.

FIG. 8 is a flowchart of an example of motor assembling method according to the disclosure.

### DETAILED DESCRIPTION

The drawings and the specification illustrate the features of the disclosure. The drawings and the specification specifically disclose one example of embodiment of the disclosure.

However, the disclosure is not limited to the embodiments described in the drawings and the specification, but encompasses all modifications, variations, and equivalents falling within the scope of the claims.

In the following description, terms such as “first,” “second,” “upper,” and “lower” are used to distinguish different elements, but these elements do not necessarily imply temporal or spatial sequence, and these elements are not to be construed as limiting by these terms. The term “and/or” includes any one and all combinations of one or more of the related terms listed. The terms “including,” “comprising,” “having,” etc., indicate the presence of a feature, element, component, or assembly, but do not exclude the presence or addition of one or more other features, elements, components, or assemblies.

In addition, terms such as “one” and “the” in singular form include plural forms and should be broadly understood as “one kind of” or “one type of” rather than being limited to the specific meaning of “one.” Also, the expression “the above-mentioned” includes both singular and plural forms unless specifically indicated otherwise in the context. Moreover, the term “based on” should be understood to mean “at least partially based on . . . ” unless specifically indicated otherwise in the context.

Further, a direction extending along the central axis of the motor or a direction in parallel thereto is referred to as “axial direction,” a direction along the radius with the central axis as the center is referred to as the “radial direction,” and a direction surrounding the central axis is referred to as the “circumferential direction.” Moreover, a direction away from the central axis along the direction of the radius is referred to as “outside in the radial direction,” and a direction toward the central axis along the direction of the radius is referred to as “inside in the radial direction.” A direction pointing from the bottom of the housing toward the opening of the housing along the axial direction is referred to as “other side in the axial direction,” “lower side in the axial direction,” “lower side,” or “below.” A direction pointing from the opening of the housing toward the bottom of the housing along the axial direction is referred to as “one side in the axial direction,” “upper side in the axial direction,” “upper side,” or “above.” These terms are used for convenience in explanation and do not limit the orientation of the motor when actually used and manufactured.

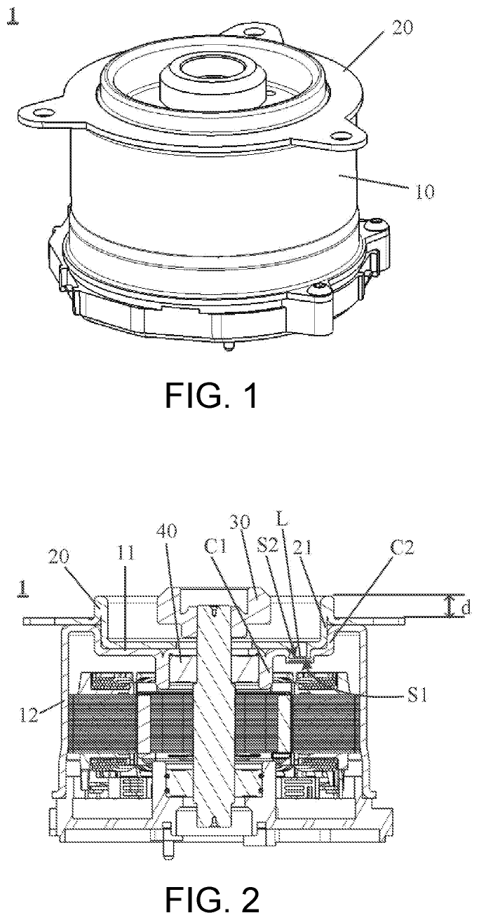

An example of motor of the disclosure is described. FIG. 1 is a perspective view of an example of motor according to the disclosure. FIG. 2 is a longitudinal cross-sectional view of the example of motor according to the disclosure.

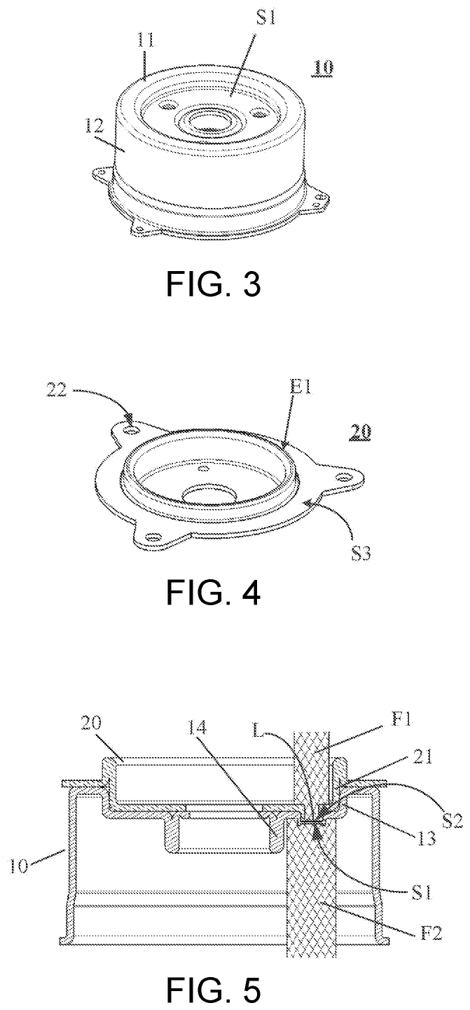

As shown in FIG. 1 and FIG. 2, a motor 1 of this embodiment includes a housing 10 and a lid 20. FIG. 3 is a perspective view of the housing 10 of the example of motor according to the disclosure. FIG. 4 is a perspective view of the lid 20 of the example of motor according to the disclosure.

As shown in FIG. 2, the housing 10 is substantially cylindrical with a bottom. The housing 10 has a bottom 11 and a wall portion 12 extending from an edge of the bottom 11 along the axial direction. The bottom 11 is a substantially disk-shaped portion. A shaft hole through which a shaft passes is provided substantially at the center of the bottom 11. The bottom 11 is recessed toward the other side in the axial direction. The wall portion 12 is a substantially cylindrical portion extending in the axial direction. The bottom 11 is connected to one side in the axial direction of the wall portion 12. The wall portion 12 has a first bending portion 13 which is described later. The bottom 11 has housing portions C1 and C2 which are described later. In this embodiment, the housing 10 is made of metal such as iron or aluminum.

The lid 20 is substantially cylindrical with a bottom. The cylindrical portion of the lid 20 extends in the axial direction. The bottom of the lid 20 is substantially disk-shaped. A hole through which a shaft passes is provided substantially at the center of the lid 20. The cylindrical portion of the lid 20 has a second bending portion 21 which is described later. The cylindrical portion of the lid 20 has an annular portion extending toward an outside in the radial direction and extending in the circumferential direction. The annular portion has at least one protrusion that projects toward the outside in the radial direction. In this embodiment, the annular portion has multiple (three) protrusions. The protrusions are evenly spaced in the circumferential direction. Each of the protrusions is provided with a through hole 22 that penetrates in the axial direction. A surface E3 is a surface on the upper axial direction of the annular portion. At least a portion of the bottom 11 of the housing 10 contacts the protrusion in the axial direction. The lid 20 is connected to the housing 10 on the one side in the axial direction (upper side in FIG. 2) of the bottom 11 of the housing 10. In this embodiment, the lid 20 is made of metal such as iron or aluminum.

An upper edge portion E1 is defined on the one side in the axial direction of the cylindrical portion of the lid 20. In this embodiment, as shown in FIG. 2 and FIG. 4, a distance d between the upper edge portion E1 of the lid 20 and a surface S3 on which the through holes 22 are defined meets the required dimension for mounting with the external device (e.g., EPS). It should be noted that in the disclosure, the value of the distance d is not limited and may be set to any value.

In this embodiment, as shown in FIG. 2 and FIG. 3, a surface on the one side in the axial direction of the bottom 11 of the housing 10 has a first connection surface S1. More specifically, the first connection surface S1 is a recessed bottom surface provided on the bottom 11 of the housing 10 and recessed toward the lower side in the axial direction. Housing portions C1 and C2 on an inside and an outside in the radial direction of the first connection surface S1 are respectively bent in opposite directions intersecting the first connection surface S1. More specifically, the housing portion C1 is substantially cylindrical and extends from a portion closer to the inside in the radial direction than the first connection surface S1 toward the other side in the axial direction. The housing portion C2 is substantially cylindrical and extends toward the one side in the axial direction on the outside in the radial direction of the first connection surface S1. In this embodiment, a bearing 40 is provided inside the housing portion C1. The housing portion C1 supports the bearing 40. Since the housing portion C2 contacts the lid 20 in the radial direction, the housing portion C2 is used to ensure the coaxiality of the lid 20. As a result, the housing portions C1 and C2 located on two sides in the radial direction of the surface (first connection surface S1) on which the connection position is provided extend in different directions from each other. Compared to a configuration in which both housing portions C1 and C2 extend in the same direction, the space above and below the axial direction of the first connection surface S1 is not restricted by both the housing portions C1 and C2, which ensures sufficient working space for the connection tool.

FIG. 2 illustrates a scenario where the housing portions C1 and C2 on the two sides in the radial direction of the first connection surface S1 are bent upward and downward in the axial direction, respectively. That is, the extending directions of the housing portions C1 and C2 located on the two sides in the radial direction of the first connection surface S1 are parallel to the axial direction. However, the disclosure is not limited thereto. The extending directions of the housing portions C1 and C2 located on the two sides in the radial direction of the first connection surface S1 may, for example, extend toward a direction that is slightly off from the axial direction to avoid the motor assembly component inside the housing, which also ensures sufficient working space for the connection tool.

Further, in FIG. 2, the housing portion C1 located on the inside in the radial direction of the first connection surface S1 extends downward, while the housing portion C2 located on the outside in the radial direction of the first connection surface S1 extends upward. However, the disclosure is not limited thereto. The housing portion C1 may extend upward and the housing portion C2 may extend downward, if necessary.

In this embodiment, the housing portion on at least one side in the radial direction of the first connection surface S1 has a double casing structure that extends along the axial direction and overlaps in the radial direction. For example, as shown in FIG. 2, the housing portion C1 on the inside in the radial direction of the first connection surface S1 extends along the axial direction and has a double casing structure. The double casing structure of the housing portion C1 is defined by bending a portion of the bottom of the housing 10 and overlapping in the radial direction. Since the rigidity is increased by the double casing structure, deformation of the first connection surface S1 is able to be suppressed, thereby suppressing the influence of the deformation of the housing 10 on the connection between the lid 20 and the housing 10 and firmly and accurately connecting the lid 20 and the housing 10.

FIG. 2 illustrates a scenario where the housing portion C1 on the inside in the radial direction of the first connection surface S1 extends along the axial direction and has a double casing structure. However, the disclosure is not limited thereto. The housing portion C2 on the outside in the radial direction of the first connection surface S1 may be designed to extend along the axial direction and have the double casing structure.

In this embodiment, as shown in FIG. 2, a motor assembly component is provided within a predetermined distance of the inside in the radial direction on at least one side in the axial direction of the first connection surface S1. For example, a coupling 30 is provided within the predetermined distance of the inside in the radial direction on the upper side in the axial direction of the first connection surface S1. The coupling 30 is, for example, connected to portion of the external device described above. Thereby, the space for disposing of the motor assembly component, such as the coupling 30, is utilized while ensuring the working space for the connection tool.

In the example of FIG. 2, the coupling 30 is located on the upper side in the axial direction of the first connection surface S1 and within the predetermined distance of the inside in the radial direction. However, the disclosure is not limited thereto. Another motor assembly component may be provided within the predetermined distance of the inside in the radial direction on the upper side in the axial direction of the first connection surface S1. Alternatively, another motor assembly component may be provided within the predetermined distance of the inside in the radial direction on the lower side in the axial direction of the first connection surface S1.

In this embodiment, as shown in FIG. 2, the motor 1 further includes a bearing 40. The bearing 40 is supported by the housing portion C1 on the inside in the radial direction of the first connection surface S1. In this embodiment, as described above, the housing portion C1 has a double casing structure, which further increases the strength supporting the bearing 40.

In this embodiment, the lid 20 has a second connection surface S2 facing the first connection surface S1, as shown in FIG. 2. More specifically, the bottom of the lid 20 has a concave portion that is recessed toward the other side in the axial direction, and the bottom surface of the concave portion is the second connection surface S2. The second connection surface S2 faces the first connection surface S1 in the axial direction. A portion on the outside in the radial direction of the second connection surface S2 extends along the one side in the axial direction to define a second bending portion 21. The second bending portion 21 is defined by bending a portion of the bottom of the lid 20 by, for example, pressing. In other words, the cylindrical portion of the lid 20 includes the second bending portion 21. In the radial direction, a TOX connection structure L that connects the housing 10 and the lid 20 is between the motor assembly component (e.g., coupling 30) and the second bending portion 21. The TOX connection structure L is recessed from the one side in the axial direction (upper side in the axial direction) toward the other side in the axial direction (lower side in the axial direction), thereby ensuring a working space for TOX caulking.

In this embodiment, the lid 20 is a single layer metal plate. As shown in FIG. 2, the first connection surface S1 and the second connection surface S2 are fixed by performing TOX caulking in the axial direction. Fixing the first connection surface S1 and the second connection surface S2 by TOX caulking allows the housing 10 and the lid 20 to be connected easily, thereby reducing the manufacturing cost of the motor.

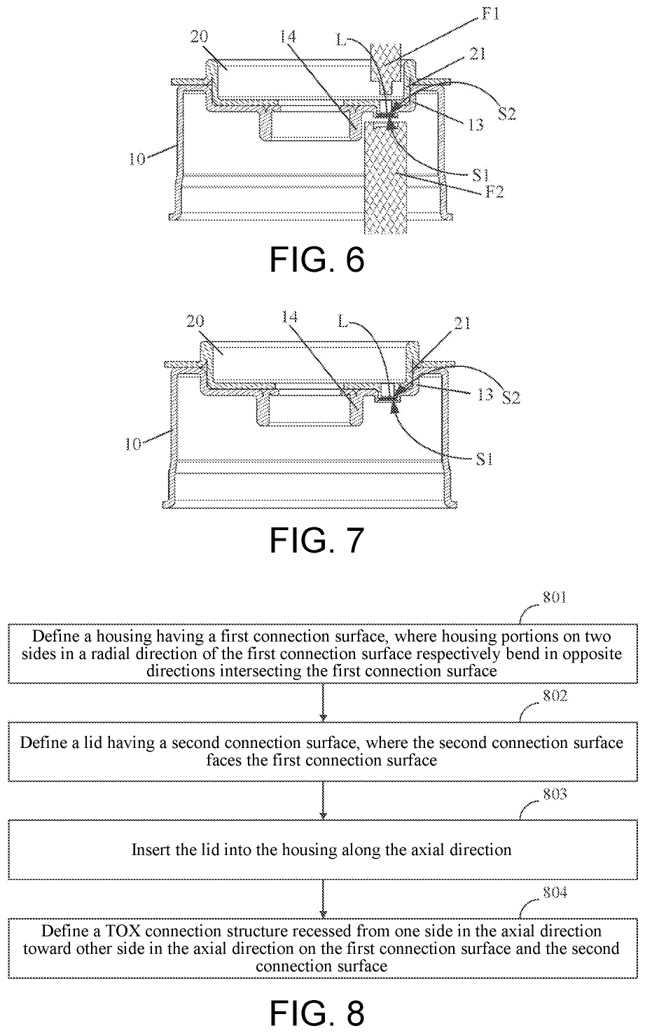

FIG. 5 to FIG. 7 are each one longitudinal cross-sectional views of the housing 10 and the lid 20 of the motor 1 and show the housing 10 and the lid 20. As shown in FIG. 5 to FIG. 7, the first connection surface S1 and the second connection surface S2 face each other in the axial direction. As shown in FIG. 5, the TOX caulking tool F1 is provided on the one side in the axial direction of the first connection surface S1. The TOX caulking tool F2 is provided on the other side in the axial direction of the second connection surface S2. The TOX caulking tools F1 and F2 are moved closer to the housing 10 and the lid 20. Then, the TOX caulking tools F1 and F2 are used to fix the first connection surface S1 and the second connection surface S2 by TOX caulking, thereby defining the TOX connection structure L and connecting the housing 10 and the lid 20. After the housing 10 and the lid 20 are connected, the TOX caulking tools F1 and F2 are moved in the axial direction respectively, and the TOX caulking tools F1 and F2 are separated from the housing 10 and the lid 20, as shown in FIG. 6 and FIG. 7.

Here, FIG. 5 shows a situation where the TOX caulking tools F1 and F2 are not separated. FIG. 6 shows a situation where the TOX caulking tools F1 and F2 are gradually separated. FIG. 7 shows a situation where the TOX caulking tools F1 and F2 are completely separated.

In this embodiment, as shown in FIG. 5 to FIG. 7, the housing portion C2 on the outside in the radial direction of the first connection surface S1 defines a first bending portion 13 by extending along the one side in the axial direction (upper side in the axial direction). That is, the first bending portion 13 is defined by bending a portion of the bottom of the housing 10. A cylindrical portion 12 of the housing 10 has the first bending portion 13. A portion on the outside in the radial direction of the second connection surface S2 extends along the one side in the axial direction to define a second bending portion 21. As for the first bending portion 13, when the lower portion of the lid portion 20, which is located closer to the outside in the radial direction than the second bending portion 21, is inserted into the inner portion of the bottom 11 of the housing 10 in the axial direction, an outer circumference surface of the second bending portion 21 is tightly fitted or loose-fitted to an inner circumference surface of the first bending portion 13.

In this embodiment, the housing 10 and the lid 20 are fixed in a tightly fitted manner. That is, in this embodiment, the outer circumference surface of the second bending portion 21 and the inner circumference surface of the first bending portion 13 are in a tightly fitted condition, which not only fixes the housing 10 and the lid 20 but also allows for centering between the housing 10 and the lid 20 to ensure the coaxiality. In addition, when the housing 10 and the lid 20 are fixed by TOX caulking as in this embodiment, the housing 10 and the lid 20 are able to be centered even if the outer circumference surface of the second bending portion 21 is loose-fitted to the inner circumference surface of the first bending portion 13.

In this embodiment, as shown in FIG. 5 to FIG. 7, the housing portion C1 on the inside in the radial direction of the first connection surface S1 defines a third bending portion 14 by extending toward the other side in the axial direction (lower side in the axial direction). The third bending portion 14 is defined by bending a portion of the bottom 11 of the housing 10. As a result, the housing portions on the two sides in the radial direction of the first connection surface S1 intersect the first connection surface S1 and are bent toward opposite directions, respectively, ensuring the working space for the TOX caulking compared to a configuration of bending toward the same direction. In other words, working spaces is ensured on the one side and the other side in the axial direction of the first connection surface S1 and the second connection surface S2, respectively. Thus, when an operator or an assembly device performs tasks such as caulking, using a tool or the like for the operation becomes much easier.

In this embodiment, as shown in FIG. 5 to FIG. 7, the third bending portion 14 has a double casing structure and supports the bearing 40 on the inside in the radial direction. Since the bearing 40 is supported by the double casing structure of the bottom 11 of the housing 10, the strength for supporting the bearing 40 is able to be increased without increasing the number of members in the motor.

Although the examples shown in FIG. 5 to FIG. 7 illustrate scenarios where the third bending portion 14 has a double casing structure, the disclosure is not limited thereto. For example, the first bending portion 13 may also has a double casing structure to further increase the strength for supporting the bearing 40 provided by the bottom 11 of the housing 10.

Only the structure related to the motor 1 of this embodiment has been described above. However, the motor is not limited to the structures described above and may also have other configurations or structures, such as a stator, a rotor, and the like.

The motor of the disclosure is not limited to a motor for EPS, and may be used for various purposes, as long as it does not deviate from the spirit of the disclosure.

According to the above embodiments, by extending the housing portions connected to the two sides in the radial direction of the surface (first connection surface) on which the connection position is provided toward directions different from each other in the axial direction, sufficient working space for the connection tool is ensured.

An example of motor assembling method of the disclosure is described below. Since the specific structure of the example of motor has already been described above, the description of the same content will be omitted.

FIG. 8 is a flowchart of a motor assembling method according to the disclosure. As shown in FIG. 8, the motor assembling method of the disclosure includes: defining a housing having a first connection surface and having housing portions on two sides in a radial direction of the first connection surface which are respectively bent in opposite directions intersecting the first connection surface (801); defining a lid having a second connection surface facing the first connection surface (802); inserting the lid into the housing along the axial direction (803); and defining a TOX connection structure recessed from one side in the axial direction toward other side in the axial direction on the first connection surface and the second connection surface (804).

It should be noted that FIG. 8 is only a schematic description of the embodiment, and the disclosure is not limited thereto. For example, the order of execution of individual steps may be adjusted appropriately, and other steps may be added or deleted. For example, step 801 and step 802 may be executed in parallel, or step 802 may be executed first and then step 801 may be executed.

In this embodiment, the housing portions respectively extend toward different axial directions on the two sides in the radial direction of the surfaces (first connection surface and second connection surface) where the connection structure with the lid is provided in the housing, thereby ensuring a sufficient working space during the connecting operation and facilitating the connecting work between the housing and the lid.

In this embodiment, the housing portion on the outside in the radial direction of the first connection surface S1 defines a first bending portion by extending along the one side in the axial direction. A lid portion on the outside in the radial direction of the second connection surface defines a second bending portion by extending along the one side in the axial direction. In step 803, the outer circumference surface of the second bending portion and the inner circumference surface of the first bending portion are assembled in a tightly fitted or loose-fitted manner. After that, the TOX connection structure is defined by executing step 804.

In this embodiment, the outer circumference surface of the second bending portion and the inner circumference surface of the first bending portion are tightly fitted to be fixed. That is, the lid is pressed into the housing, and the housing and the lid are fixed in a tightly fitted manner. In addition to fixing between the housing and the lid, the housing and the lid are able to be centered to maintain coaxiality. Moreover, as shown in this embodiment, when the housing and the lid are connected by TOX caulking, the housing and the lid are able to be centered even in a loose-fitted manner.

Illustrative embodiments of the present disclosure are described above in detail with reference to the drawings to illustrate the forms in which the principles of the present disclosure may be employed. While examples of embodiments of the present disclosure have been described above, it is to be understood that variations and modifications will be apparent to those skilled in the art without departing from the scope and spirit of the present disclosure.

What is claimed is:

1. A motor, comprising:
a housing having a bottom and a wall portion extending from an edge of the bottom along an axial direction; and
a lid connected to the housing on one side in the axial direction of the bottom of the housing,
wherein a surface on the one side in the axial direction of the bottom of the housing has a first connection surface, and housing portions on an inside and an outside in a radial direction of the first connection surface are respectively bent in opposite directions intersecting the first connection surface.

2. The motor according to claim 1, wherein the housing portion on at least one side in the radial direction of the first connection surface has a double casing structure extending along the axial direction and overlapping in the radial direction.

3. The motor according to claim 2, comprising a motor assembly component within a predetermined distance on the inside in the radial direction on at least one side in the axial direction of the first connection surface.

4. The motor according to claim 3, further comprising a bearing, wherein the housing portion on the inside in the radial direction of the first connection surface supports the bearing.

5. The motor according to claim 3, wherein
the lid has a second connection surface facing the first connection surface,
a lid portion on the outside in the radial direction of the second connection surface defines a second bending portion by extending along the one side in the axial direction,
a TOX connection structure connecting the housing and the lid is between the motor assembly component and the second bending portion in the radial direction, and
the TOX connection structure is recessed from the one side in the axial direction toward other side in the axial direction.

6. The motor according to claim 1, wherein
the lid is a single layer metal plate,
a surface of the lid facing the first connection surface is a second connection surface, and
the first connection surface and the second connection surface are fixed in the axial direction by TOX caulking.

7. The motor according to claim 6, wherein
the housing portion on the outside in the radial direction of the first connection surface defines a first bending portion by extending along the one side in the axial direction,
a lid portion on the outside in the radial direction of the second connection surface defines a second bending portion by extending along the one side in the axial direction, and
an outer circumference surface of the second bending portion is tightly fitted or loose-fitted to an inner circumference surface of the first bending portion.

8. The motor according to claim 1, wherein
the housing portion on the outside in the radial direction of the first connection surface defines a first bending portion by extending toward the one side in the axial direction and, and
the housing portion on the inside in the radial direction of the first connection surface defines a third bending portion by extending toward other side in the axial direction.

9. The motor according to claim 8, wherein
the third bending portion has a double casing structure,
the motor further comprises a bearing, and
the third bending portion supports the bearing on the inside in the radial direction.

10. A motor assembling method for assembling a motor which comprises a bottom and a wall portion extending from an edge of the bottom along an axial direction and in which a surface on one side in the axial direction of the bottom of a housing has a first connection surface, the motor assembling method comprising:
defining the housing having housing portions on two sides in a radial direction of the first connection surface, which are respectively bent in opposite directions intersecting the first connection surface;
defining a lid whose surface facing the first connection surface is a second connection surface;
inserting the lid into the housing along the axial direction; and
defining a TOX connection structure recessed from the one side in the axial direction toward other side in the axial direction on the first connection surface and the second connection surface.

11. The motor assembling method according to claim 10, wherein
the housing portion on an outside in the radial direction of the first connection surface defines a first bending portion by extending along the one side in the axial direction,
a lid portion on the outside in the radial direction of the second connection surface defines a second bending portion by extending along the one side in the axial direction, and
inserting the lid into the housing along the axial direction comprises defining the TOX connection structure by performing TOX caulking after assembling an outer circumference surface of the second bending portion and an inner circumference surface of the first bending portion in a tightly fitted or loose-fitted manner.
